(19) United States
(12) Patent Application Publication
(10) Pub. No.: US 2024/0322484 A1
(43) Pub. Date: Sep. 26, 2024

(54) PLUG FOR A VEHICLE-ELECTRICAL-SYSTEM-VOLTAGE RECEPTACLE

(71) Applicant: Aircom Automotive Sp. z o.o. Sp. k., PIETRZYKOWICE (PL)

(72) Inventors: Dominik Gschwender, Steckborn (CH); Grzegorz Batycki, Bielany Wroclawskie (PL); Jakub Jeskowiak, Ujazd Górny (PL)

(21) Appl. No.: 18/577,232

(22) PCT Filed: Jun. 27, 2022
(86) PCT No.: PCT/EP2022/067594

§ 371 Date: Jan. 5, 2024

(30) Foreign Application Priority Data
Jul. 9, 2021 (DE) 10 2021 117 779.0

(51) Int. Cl. H01R 13/533; H01R 13/05; H01R 13/10

(52) U.S. Cl. CPC H01R 13/533; H01R 13/052; H01R 13/10; H01R 2201/26

(57) ABSTRACT

The invention relates to a plug (10) for a vehicle-electrical-system-voltage receptacle, the plug (10) comprising: —a front plug portion (12), which is to be arranged at the front as the plug is inserted into the vehicle-electrical-system-voltage receptacle and which has a first contact element (20) for contacting the vehicle-electrical-system-voltage receptacle; —a rear plug portion (14); and—a middle plug portion (16), which is located between the front plug portion (12) and the rear plug portion (14); wherein: a second contact element (22) for contacting the vehicle-electrical-system-voltage receptacle is disposed in the middle plug portion (16); the middle plug portion (16) comprises at least one contact region (24) and at least one ventilation region (26); the first contact region (24) is complementary to an interior (6) of the socket (4) such that, when the plug (10) is disposed in the vehicle-electrical-system-voltage receptacle, a first distance (al) is established between the socket (4) and the contact region (24); and a curvature of the ventilation region (26) deviates from a curvature of the interior (6) of the socket (4) such that, when the plug (10) is disposed in the vehicle-electrical-system-voltage receptacle, a second distance (a2) is established between the ventilation region (26) and the socket (4), the second distance (a2) being greater than the first distance (al) so that at least one ventilation channel (28) is formed between the front plug portion and the rear plug portion.

The invention relates to a plug for a vehicle-electrical-system-voltage receptacle, in particular for a vehicle-electrical-system-voltage receptacle of a motor vehicle.

Such plugs and vehicle-electrical-system-voltage receptacles are also known as “cigarette lighters” in a motor vehicle.

Such a vehicle-electrical-system-voltage receptacle usually has a contact arranged on a base of the vehicle-electrical-system-voltage receptacle and connected to a pole of a first polarity of an electrical power source, in particular a vehicle battery, and a socket connected to a pole of a second polarity of the electrical power source.

The plug comprises a front plug portion which is to be arranged at the front as the plug is inserted into the vehicle-electrical-system-voltage receptacle, a rear plug portion arranged opposite the front plug portion, and a middle plug portion which is located between the front plug portion and the rear plug portion. In the front plug portion, a first contact element is arranged in the region of a central plug axis for contacting the contact of the vehicle-electrical-system-voltage receptacle. Furthermore, at least one second contact element for contacting an interior of the socket of the vehicle-electrical-system-voltage receptacle is arranged in a middle plug portion of the plug.

The present invention is based on the object of further developing and improving a plug for a vehicle-electrical-system-voltage receptacle.

According to the invention, it is proposed that the middle plug portion comprises at least one first contact region, comprising the second contact element, and at least one first ventilation region, wherein a curvature of a surface of the first contact region is designed to be complementary to a curvature of the interior of the socket such that, in a state of the plug disposed in the vehicle-electrical-system-voltage receptacle as intended, no distance or a first distance is established between the interior of the socket and the surface of the first contact region, and wherein a curvature of a surface of the first ventilation region deviates from the curvature of the interior of the socket such that, in the state of the plug disposed in the vehicle-electrical-system-voltage receptacle as intended, a second distance is formed between the surface of the first ventilation region and the interior of the socket, wherein the second distance is greater than the first distance between the interior of the socket and the surface of the first contact region, so that in the state of the plug disposed in the vehicle-electrical-system-voltage receptacle as intended, at least one ventilation channel is formed between the front plug portion and the rear plug portion.

The vehicle-electrical-system-voltage receptacle and thus the socket of the vehicle-electrical-system-voltage receptacle is designed, for example, in accordance with the SAE J563 specification or the DIN ISO 4165 specification or the SAE/USCAR-4-1 specification.

In accordance with the SAE J563 standard, it is provided that the contact arranged on the base of the vehicle-electrical-system-voltage receptacle is connected to the positive pole of the electrical power source, in particular the vehicle battery, and the socket itself is connected to the negative pole.

In the plugs known from the prior art for such vehicle-electrical-system-voltage receptacles, it is provided that the plug, at least the part of the plug to be disposed in the socket, substantially has a cylindrical shape with a diameter which is only slightly smaller than the inner diameter of the socket, so that the plug can be disposed in the vehicle-electrical-system-voltage receptacle and, when disposed in its intended state, contacts the interior of the socket almost circumferentially or there is only a very small distance of approximately 0.01 mm to 0.3 mm, at most up to 0.6 mm, between the plug and the interior of the socket. The at least one second contact element of the plug is usually a resilient contact which is pressed against the interior of the socket when the plug is disposed in its intended state. The distance is thus bridged by the second contact element of the plug.

Exemplary dimensions of a vehicle-electrical-system-voltage receptacle in accordance with the SAE J563 standard comprise an inner diameter of the socket of approximately 21 mm, in particular 20.9 mm to 21.1 mm, and in accordance with DIN ISO 4165 an inner diameter of about 12 mm. The diameter of the plug known from the prior art is approximately 0.2 mm to 0.3 mm smaller than the inner diameter of the corresponding socket.

According to the invention, it is provided that the middle plug portion comprises at least one first contact region and at least one first ventilation region. The first contact region comprises the at least one second contact element. In state of the plug disposed in the vehicle-electrical-system-voltage receptacle as intended, no distance or a first distance is established between the inside of the socket and the surface of the first contact region. This distance is bridged by the second contact element of the plug, which contacts the interior of the socket.

In the state of the plug disposed in the vehicle-electrical-system-voltage receptacle as intended, a second distance is established between the inside of the socket and the surface of the first ventilation region. The second distance is greater than the first distance between the inside of the socket and the surface of the first contact region, so that, in the state of the plug disposed in the vehicle-electrical-system-voltage receptacle as intended, at least one ventilation channel is formed between the front plug portion and the rear plug portion. The ventilation channel is formed between the front plug portion and the rear plug portion over an extension of the middle plug portion between the front plug portion and the rear plug portion.

A ratio of external dimensions, for example a diameter, of the plug in the contact region and outer dimensions, for example a diameter, of the plug in the ventilation region is, for example, 5:4. The diameter of the plug in the contact region is between 20 mm to 22 mm, for example, in accordance with the dimensions of the SAE J563 specification. The diameter of the plug in the ventilation region is then, for example, between 15 mm and 20 mm, in particular between 16 mm and 18 mm. Other ratios of diameters of the plug in the contact region to the diameter of the plug in the ventilation region, for example between 5:1 and 5:4, are also conceivable.

The plug according to the invention can be used to provide ventilation and thus better cooling. The plug can thus be used for electrical devices with higher power consumption.

Furthermore, the plug is more material-efficient and requires less installation space compared to plugs known from the prior art.

It may prove advantageous if the first distance is at most 0.01 mm to 0.6 mm and/or the second distance is at least 0.3 mm to 1.2 mm or more.

It proves to be advantageous for the plug to be designed at least partially in accordance with the SAE J563 specification or the DIN ISO 4165 specification. For example, the geometry of the plug according to the invention may result in a deviation from the dimensions of the plug specified in the SAE J563 or DIN ISO 4165 specifications. Additional requirements, for example with regard to the contacts of the plug, are advantageously met.

In a further development of the inventive idea, it may prove advantageous if the surface of the middle plug portion comprises at least two contact regions for contacting the interior of the socket and at least two ventilation regions. Further contact regions and/or further ventilation regions may also be provided.

It proves to be advantageous if the first and the second contact region and the first and the second ventilation region are each arranged opposite one another in relation to the plug axis.

Furthermore, it may prove advantageous if the surface of the at least first ventilation region is at least partially designed as a flat surface. In this case, the curvature of the surface of the at least first ventilation region is equal to zero.

It may also be advantageous for the surface of the at least first ventilation region to be at least partially concavely curved.

It may also be advantageous for the surface of the at least first ventilation region to be at least partially convexly curved.

In a further development of the present invention, it is provided that the first contact element of the plug, which is formed in the region of the central plug axis, comprises a contact pin with an elastomer sleeve, in particular comprising rubber, in particular silicone, surrounding the contact pin.

In order to ensure good electrical contact, the contact pin must be pressed onto the contact located at the base of the vehicle-electrical-system-voltage receptacle with a certain force. The elastomer sleeve acts as a spring element. The use of steel springs is known from the prior art. The use of an elastomer sleeve can be advantageous for automatic assembly. Conventional steel springs can become entangled with the other springs.

Further embodiments relate to an electrical device which is designed to be operated with electrical power, comprising a connection element for connecting the electrical device to an electrical power source, characterized in that the connection element is designed as a plug according to the embodiments described above.

According to one embodiment, it is provided that the device comprises a receptacle for the plug, in which the plug can be disposed when the electrical device is not connected to the electrical power source via the plug. The receptacle for the plug is advantageously designed to be complementary to the shape of the plug. The receptacle for a plug according to the invention advantageously requires less installation space than a receptacle for a plug known from the prior art.

The electrical device is, for example, a compressed air supply system with a compressor. Such systems usually have a power consumption of approximately 80 W to 240 W. The plug according to the invention ensures a correspondingly required heat dissipation via the ventilation channel.

Further features, possible applications and advantages of the invention are apparent from the following description of embodiments of the invention, which are shown in the figures of the drawing. In this case, all of the features described or shown form the subject matter of the invention per se or in any combination, irrespective of their grouping in the claims or their dependency reference, and irrespective of their wording or representation in the description or in the drawings.

In the drawings:

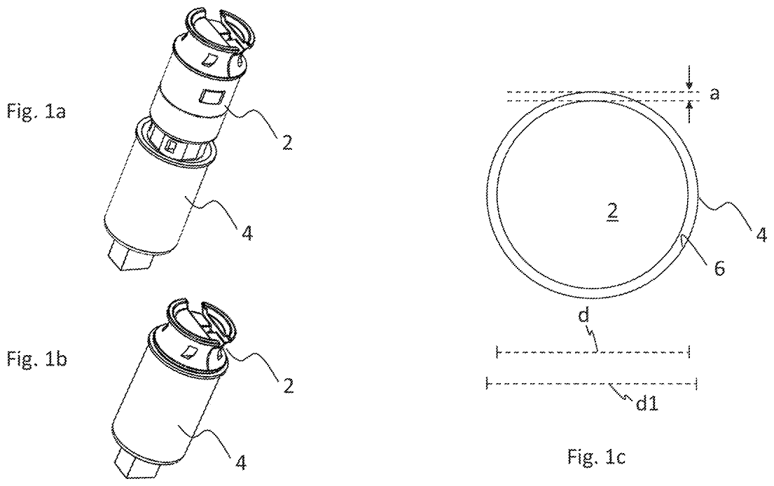

FIGS. 1a to 1c show different views of a plug known from the prior art in various application situations in relation to a schematically depicted socket of a vehicle-electrical-system-voltage receptacle;

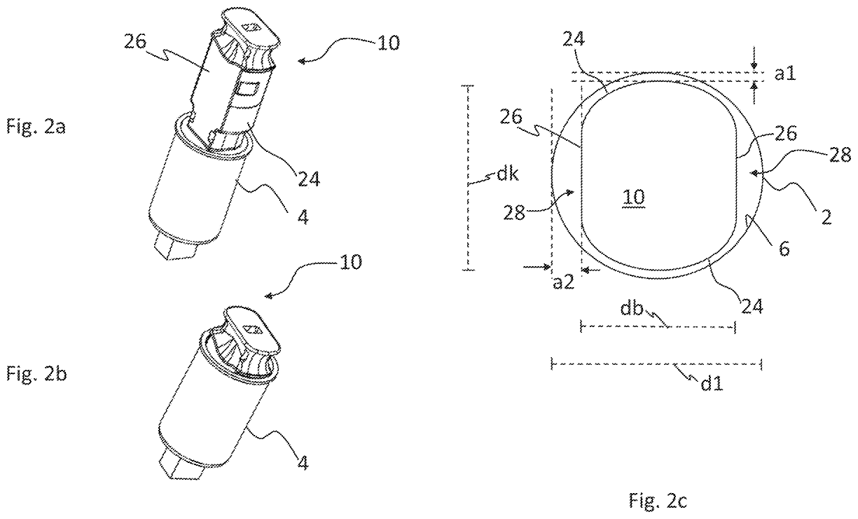

FIGS. 2a to 2c show different views of a plug according to the invention in various application situations in relation to a schematically depicted socket of a vehicle-electrical-system-voltage receptacle;

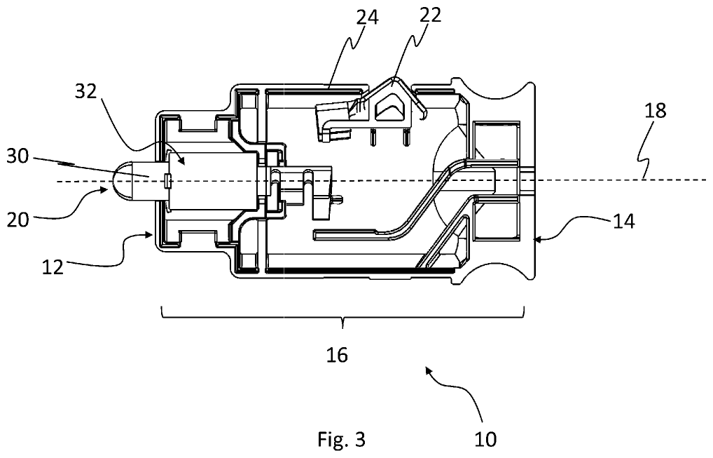

FIG. 3 shows a sectional view of a plug according to the invention from the side;

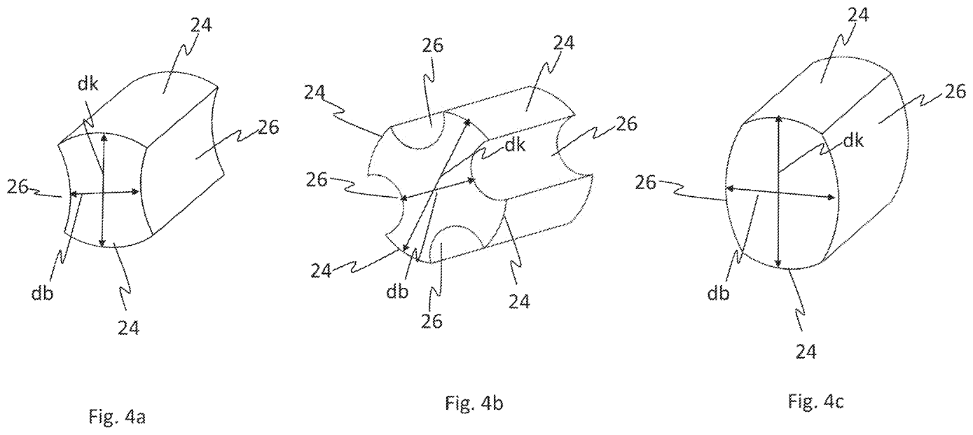

FIGS. 4a to 4c show schematic views of a plug according to the invention according to further embodiments, and

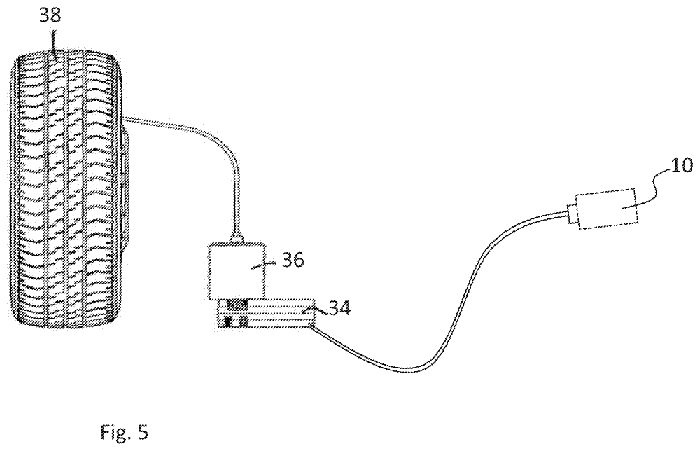

FIG. 5 shows a schematic view of an electrical device having a plug according to the invention.

FIGS. 1a to 1c show different views of a plug 2 known from the prior art in various application situations in relation to a schematically depicted socket 4 of a vehicle-electrical-system-voltage receptacle.

The vehicle-electrical-system-voltage receptacle comprises a contact arranged on a base of the vehicle-electrical-system-voltage receptacle and connected to a pole of a first polarity of an electrical power source, and the socket 4 connected to a pole of a second polarity of the electrical power source.

In the case of plug 2 known from the prior art, it is provided that outer dimensions, namely diameter d of plug 2, are only slightly smaller than the inner diameter d1 of the socket 4, so that the plug can be disposed in the vehicle-electrical-system-voltage receptacle and, when disposed in the intended state, contacts the interior 6 of the socket 4 almost circumferentially or there is only a very small distance a of approximately 0.01 mm to 0.6 mm between the plug and the interior of the socket, cf. FIG. 1c.

With reference to FIGS. 2 to 5, a plug 10 according to the invention is explained below.

FIGS. 2a to 2c show different views of plug 10 according to the invention in various application situations in relation to the schematically depicted socket 4 of a vehicle-electrical-system-voltage receptacle. FIG. 3 shows a sectional view of plug 10 according to the invention from the side.

The plug 10 comprises a front plug portion 12, a rear plug portion 14 arranged opposite the front plug portion 12, and a middle plug portion 16 arranged between the front plug portion 12 and the rear plug portion 14.

The front plug portion 12 is to be arranged at the front when inserted into the socket 4. In the region of a central plug axis 18, a first contact element 20 for contacting a corresponding contact of the vehicle-electrical-system-voltage receptacle is arranged on the front plug portion 12.

A second contact element 22 for contacting the interior 6 of the socket 4 of the vehicle-electrical-system-voltage receptacle is arranged in the middle plug portion 16.

The middle plug portion 16 comprises at least one first contact region 24, which comprises the second contact element 22, and at least a first ventilation region 26.

In a state of the plug disposed in the vehicle-electrical-system-voltage receptacle as intended, no distance or a first distance a1 is established between the interior 6 of the socket 4 and a surface of the first contact region 24, cf. FIG. 2c. A curvature of the surface of the first contact region 24 is designed to be complementary to a curvature of the interior 6 of the socket 4.

In the state of the plug disposed in the vehicle-electrical-system-voltage receptacle as intended, a second distance a2 is established between a surface of the first ventilation region 26 and the interior 6 of the socket 4.

The second distance a2 is greater than the first distance a1 between the interior 6 of the socket 4 and the surface of the first contact region 24. In this manner, in the state of the plug 10 disposed in the on-board voltage socket as intended, at least one ventilation channel 28 is formed in the ventilation region 26 between the front plug portion 12 and the rear plug portion 14. The ventilation channel 28 is formed between the front plug portion 12 and the rear plug portion 14 over an extension of the middle plug portion 16 between the front plug portion 12 and the rear plug portion 14.

The first distance a1 is, for example, at most 0.01 mm to 0.6 mm. The second distance a2 is, for example, at least 0.3 mm to 1.2 mm or more.

The plug 10 comprises external dimensions, in particular a diameter dk in the contact region 24 and a diameter db in the ventilation region 26. One diameter runs respectively through the plug axis 18. The diameter db is smaller than the diameter dk. A ratio of the two diameters of the plug dk to db is, for example, between 5:1 and 5:4.

According to the embodiment shown in FIGS. 2a to 2c, 3, two contact regions 24 each and two ventilation regions 26 each are provided, with the contact regions 24 and the ventilation regions 26 being each arranged opposite one another in relation to the plug axis 18.

According to the embodiment shown in FIGS. 2a to 2c, the surface of the at least first ventilation region 26 is designed as a flat surface. In this case, the curvature of the surface of the at least first ventilation region 26 is equal to zero.

FIGS. 4a to 4c show further exemplary design options for the plug 10. According to FIGS. 4a and 4b, the surface in the ventilation regions 24 is concavely curved, i.e., inwardly curved in the contact regions compared to the outwardly curved surface.

According to FIG. 4c, the surface is convexly curved in the ventilation regions, cf. 4c. However, the radius of curvature of the surface in the ventilation regions deviates from the radius of curvature of the surface in the contact regions.

According to the embodiment shown in FIG. 3, the first contact element 20 of the plug 10 formed in the region of the central plug axis 18 comprises a contact pin 30 with an elastomer sleeve 32, in particular made of rubber, in particular silicone, surrounding the contact pin 30. The elastomer sleeve 32 acts as a spring element and presses the contact pin 30 onto the contact arranged at the base of the vehicle-electrical-system-voltage receptacle with a certain force.

Finally, FIG. 5 shows an electrical device 34 which is designed to be operated with electrical power, comprising a plug 10 for connecting the electrical device to an electrical power source.

The device 34 comprises a receptacle for plug 10, not shown in detail, in which plug 10 can be arranged when the electrical device 34 is not connected to the electrical power source via plug 10. The receptacle for the plug is advantageously designed to be complementary to the shape of plug 10. The receptacle for a plug according to the invention advantageously requires less installation space than a receptacle for a plug known from the prior art.

For example, a plug designed in accordance with FIGS. 2 and 3 requires approximately 28% less space than a conventional plug, cf. FIG. 1. Furthermore, the amount of material required to manufacture the plug is reduced by approximately 23%.

The electrical device 34 is, for example, a compressed air supply system with a compressor. According to the embodiment shown, the compressed air supply system is connected to a pneumatic tire 38 to be sealed or inflated via a sealing fluid reservoir 36. The electrical device is, for example, a compressed air supply system with a compressor. Such systems usually have a power consumption of approximately 80 W to 240 W. The plug 10 according to the invention ensures a correspondingly required heat dissipation via the ventilation channel.

1-12. (canceled)

13. A plug (10) for a vehicle-electrical-system-voltage receptacle of a motor vehicle, the vehicle-electrical-system-voltage receptacle having a contact arranged on a base of the vehicle-electrical-system-voltage receptacle and being connected to a pole of a first polarity of an electrical power source, and a socket (4) connected to a pole of a second polarity of the electrical power source, the plug comprising:
a front plug portion (12) which is to be arranged at a front as the plug is inserted into the vehicle-electrical-system-voltage receptacle and on which, in the region of a central plug axis (18),
a first contact element (20) for contacting the contact of the vehicle-electrical-system-voltage receptacle is arranged,
a rear plug portion (14) which is located opposite the front plug portion (12), and
a middle plug portion (16) which is located between the front plug portion (12) and the rear plug portion (14), wherein a second contact element (22) for contacting an interior (6) of the socket (4) of the vehicle-electrical-system-voltage receptacle is disposed in the middle plug portion (16), wherein the middle plug portion (16) includes:
at least one first contact region (24), including the second contact element (22),
at least one further second contact region (24), and
at least one first and one second ventilation region (26),
wherein a curvature of a surface of the first and the second contact region (24) is designed to be complementary to a curvature of the interior (6) of the socket (4) such that, in a state of the plug (10) disposed in the vehicle-electrical-system-voltage receptacle as intended, no distance or a first distance (a1) is established between the interior (6) of the socket (4) and the surface of the first contact region (24) as well as between the interior (6) of the socket (4) and the surface of the second contact region (24), and
wherein a curvature of a surface of the first and the second ventilation region (26) deviates from the curvature of the interior (6) of the socket (4) such that, in the state of the plug (10) disposed in the vehicle-electrical-system-voltage receptacle as intended, a second distance (a2) is established between the surface of the first ventilation region (26) and the interior (6) of the socket (4) and between the surface of the second ventilation region (26) and the interior (6) of the socket (4), the second distance (a2) being greater than the first distance (a1) between the interior (6) of the socket (4) and the surface of the first contact region (24), characterized in that:
the first and the second contact region (24) and the first and the second ventilation region (26) in relation to the plug axis (18) are each arranged opposite one another and, in the state of the plug (10) disposed in the vehicle-electrical-system-voltage receptacle as intended, at least two ventilation channels (28) are formed between the front plug portion (12) and the rear plug portion (14).

14. The plug (10) according to claim 1, characterized in that the first distance (a1) is 0.01 mm to 0.6 mm, and/or in that the second distance (a2) is at least 0.3 mm to 1.2 mm or more.

15. The plug (10) according to claim 1, characterized in that the plug (10) is designed at least partially in accordance with the SAE J563 specification or the DIN ISO 4165 specification.

16. The plug (10) according to claim 1, characterized in that the surface of the at least first ventilation region (26) is at least partially designed as a flat surface.

17. The plug (10) according to claim 1, characterized in that the surface of the at least first ventilation region (26) is at least partially concavely curved.

18. The plug (10) according to claim 1, characterized in that the surface of the at least first ventilation region (26) is at least partially convexly curved.

19. The plug according to claim 1, characterized in that the first contact element (20) of plug (10) formed in the region of the central plug axis (18) comprises a contact pin (30) with an elastomer sleeve (32) comprising silicone surrounding the contact pin (30).

20. An electrical device (34) which is designed to be operated with electrical power, comprising a connection element for connecting the electrical device to an electrical power source, characterized in that the connection element is designed as a plug (10) according to claim 1.

21. The electrical device (34) according to claim 20, characterized in that device (34) comprises a receptacle for plug (10), in which plug (10) can be disposed when the electrical device (34) is not connected to the electrical power source via the plug (10).

22. The electrical device (34) according to claim 20, characterized in that the electrical device (34) is a compressed air supply system with a compressor.
